(19) United States
(12) Patent Application Publication
(10) Pub. No.: US 2025/0331064 A1
(43) Pub. Date: Oct. 23, 2025

(54) POWER CONTROL UNIT AND ARRANGEMENT OF SUCH A POWER CONTROL UNIT WITH AN ELECTRIC HEATING DEVICE

(71) Applicant: E.G.O. Elektro-Geraetebau GmbH, Oberderdingen (DE)

(72) Inventors: Robin Abendschoen, Eppingen (DE); Mario Funk, Karlsdorf-Neuthard (DE); Achim Marx, Oberderdingen (DE)

(21) Appl. No.: 18/549,623

(22) PCT Filed: Mar. 10, 2022
(86) PCT No.: PCT/EP2022/056122

§ 371 Date: Jul. 22, 2024

(30) Foreign Application Priority Data
Mar. 10, 2021 (DE) 10 2021 202 314.2

(51) Int. Cl. H05B 1/02; H05B 3/06

(52) U.S. Cl. CPC H05B 1/0213; H05B 3/06; H05B 2203/02; H05B 2203/032; H05B 2203/035

(57) ABSTRACT

A power control unit for controlling a power output of an electric heating device is designed as an assembly and has a power switch and a release mechanism therefor. The release mechanism has a bimetallic release and a heating device therefor. The heating device has a two-dimensional carrier with an electrically insulating top side, on which a heating conductor is arranged. For a quicker switching behavior, the carrier may consist of ceramic and have a thickness of less than 1.5 mm or the power control unit may have an elongate compensation bimetallic strip, which has a freely movable compensation end. This is pressed against the release mechanism and can compensate for changes in the ambient temperature, which also affect the bimetallic release.

### AREA OF APPLICATION AND PRIOR ART

### Area of Application and Prior Art

The invention relates to a power control unit for controlling or setting a power output of an electric heater, and to an arrangement of such a power control unit with an electric heater. In particular, the power control unit is arranged together with the electric heater in a hob. Advantageously, the hob has a plurality of heaters, each of which is associated with its own power control unit.

Such power control units are known from U.S. Pat. No. 6,211,582 B1. They control the power output of an electric heater by cyclic operation, i.e. in that the heater is either operated at full power during a switched-on time or switched off during a switched-off time. The ratio between these two times determines the average continuous power which supplies the electric heater and which is converted by the heater into heat.

An aforementioned power control unit known from the prior art has a mechanical adjustment device using which the aforementioned durations of the switched-on time and the switched-off time may be changed. There is often a demand for a very precise setting of the continuous power output from the electric heater controlled by it. This does not play any noteworthy role in the case of high or very high continuous power outputs from the electric heater, but it does in the case of very low continuous power outputs. Such low power outputs are needed for example for certain sauces or for melting chocolate or similar temperature-sensitive food.

### Object and Solution

The object underlying the invention is to provide a power control unit as stated at the outset and an arrangement of such a power control unit with an electric heater that is controlled thereby, using which problems of the prior art can be solved and in particular an increase in precision is made possible when controlling the power, preferably in the lower power range.

This object is solved by a power control unit having the features of claim 1 and by an arrangement having the features of claim 20. Advantageous and preferred embodiments of the invention are the subject matter of further claims and are explained in greater detail below. Some of the features are described only for the power control unit or only for the arrangement. They are however intended to apply by themselves and independently of one another both for a power control unit as well as an electrical arrangement. The wording of the claims is incorporated by express reference into the content of the description.

The power control unit is designed as an assembly, in particular arranged inside a housing. It has a power switch designed as a snap-action switch or as a catch spring. The power switch is a mechanical switch. It has an elongate switching arm having at a contact end a power switching contact. This power switching contact may be pressed by the switching arm against a mating contact of the power control unit, thereby closing the power switch. After opening, the power switching contact has a certain distance from the mating contact. Closing and opening is very fast/abrupt, which is achieved in known manner by its configuration as a snap-action switch. To operate/release the power switch, a release mechanism having a release is provided. This release is in contact with the other switching arm end and may trigger a switching operation, i.e. may open or close the power switch.

The release mechanism thus has the release which incorporates a bimetal or is formed by a bimetal or consists of a bimetal, advantageously in an elongate strip shape or as an elongate arm. The release mechanism furthermore has a heating device for the release, as is known per se from the prior art. The release has a free release end by which it is in contact with the aforementioned switching arm end of the switching arm of the power switch in order to release or operate it. Another end of the release is preferably firmly arranged or fastened on the release mechanism. The heating device extends a short distance from the release, advantageously less than 2 mm in the state of the release at room temperature. Furthermore, the heating device may be designed elongate and extend at least partially along the release or in the same direction in principle, preferably at least overlapping.

The heating device has a two-dimensional carrier, which has an electrically insulating top side on which a heating conductor is arranged. Advantageously, the heating conductor is designed as a thick-film-heating conductor, alternatively as a thin-film heating conductor. The heating conductor is preferably arranged on the top side, facing away from the release, of the carrier of the heating device. Alternatively, it may also be arranged on that side facing toward the release, allowing an even faster heating up of the release to be achieved due to radiated heat. An electrically insulating cover or coating is then advantageously provided.

One aspect of the invention is that the carrier consists of a ceramic and has a thickness of less than 1.5 mm. Advantageously, the thickness is even less than 1 mm, and particularly advantageously it is between 0.1 mm or 0.4 mm and 0.75 mm.

Another aspect of the invention provided additionally or alternatively to the aforementioned aspect of the ceramic carrier is that the power control unit has an elongate compensation bimetallic strip. This compensation bimetallic strip has a freely movable compensation end and an opposite fastening end. While the compensation end is pressed directly or indirectly against the release mechanism, it is fastened with the other fastening end to the power control unit. It may thus be fastened for example to a sturdy metal bridge, on which other aforementioned function units, advantageously the release mechanism and the power switch, are also fastened. The bridge may be a connecting bridge, on which preferably the release mechanism and/or the power switch are also fastened, advantageously in spring manner and/or movably. The connecting bridge is advantageously arranged firmly and immovably on the housing, in particular on a housing floor, particularly advantageously integrally molded or plugged in. The compensation bimetallic strip is preferably a material SBCL/DS/751-108, such as is available from the company Shivalik. Preferably, the compensation bimetallic strip may be fastened by the fastening end to the power control unit, in particular to an aforementioned bridge or connecting bridge which is fastened firmly, and advantageously immovably, to a housing of the power control unit. The connecting bridge may form the stop for the compensation bimetallic strip, so that a distance between them or a maximum travel for the compensation bimetallic strip up to the stop is 1.0 mm, preferably at most 0.8 mm. It may be at least 0.1 mm or at least 0.2 mm.

The compensation bimetallic strip and the release mechanism are spring-loaded relative to one another and are in contact with one another or pressed against one another in spring manner. This spring-loaded contact is advantageously achieved by a correspondingly spring-like and pretensioned embodiment of the release mechanism or by its fastening to the power control unit, for example by means of a spring metal strip. Furthermore, the compensation bimetallic strip is designed such that a movement direction of its free compensation end is at an angle of between 0° and 45° to the movement direction of that area of the release mechanism which the compensation end is in contact with or is pressed against.

The low thickness of the carrier made of a ceramic effects a low thermal capacity. This in turn means that the heating device heats up very fast and hence can heat the bimetallic release very fast, so that the latter deforms in order to release or operate the power switch, in particular to open it quickly. The result of this is that only a short time, advantageously 2 sec to 5 sec, passes from the time that heating of the heating device starts until the power switch is opened. Fast opening of the power switch effects above all an increase in the control precision of the power output from the heating device in the low continuous power range.

Providing a compensation bimetallic strip not only enables differing room temperatures or ambient temperatures to be taken into account, that are in the Central European region anyway only in a relatively narrow range between 5° C. and a maximum of 35° C.; instead, when installed in a hob, the power control unit, which may have already been in operation for a lengthy period, in particular when an oven arranged underneath it is also heated up over a lengthy period, may also be subjected to markedly higher temperatures of over 50° C. The average temperatures resulting during operation of the oven are around 80° C. in the cooker and also at the power control unit, possibly up to 125° C. This influences the behavior of the bimetallic release in an unpredictable manner, so that the influence of the ambient temperature on the bimetallic release may be cancelled out at least partially, advantageously largely, or even completely by the compensation bimetallic strip. The precise dimensioning and the material selected for the compensation bimetallic strip, and its arrangement relative to the release mechanism with the bimetallic release, are an interpretation that is easily implementable by the person skilled in the art. The preferred material is SBCL/DS/751-108, made by Shivalik. With the compensation bimetallic strip, it is possible to achieve high precision above all in low power outputs that are to be set or effected using the power control unit, advantageously in the range of the lowest power outputs, when the switched-on duration is much shorter than the switched-off duration.

In an advantageous embodiment, the compensation bimetallic strip has a specific thermal curvature of between 0.00003/K and 0.00006/K, in particular of 0.000043/K. This is relatively low, but sufficient for the compensatory effect if the differences in the ambient temperature are as previously described. The provision of only one of these two aspects is already regarded as sufficient for improving the switching precision of the power control unit in accordance with the invention, in particular in the low continuous power range. If both aspects are provided together, this improvement is obviously even greater.

In an embodiment of the invention, the compensation bimetallic strip is designed such that its free and movable compensation end moves away from the release mechanism as the temperature rises. The freely movable compensation end thus moves in the direction approximately opposite to the release or to the free release end. This allows the influence of a variable and in particular rising ambient temperature on the release or on the release mechanism to be reduced or eliminated precisely by compensating for it.

In a preferred embodiment of the invention, the complete release is designed as a bimetallic strip. It may have a consistent width and, at the release end, be bent into a round hook in order to be in readily movable contact with the switching arm end of the power switch switching arm. However, this is known per se from the prior art.

In a possible embodiment of the invention, the release mechanism is fastened or mounted in spring manner on the power control unit. A spring metal is advantageously provided here which can also perform the supply of current to the heating device. Furthermore, a receptacle for the heating device may be provided on this spring part, so that the heating device only has to be plugged in, for example, and is then mechanically held and brought into electric contact. The release is advantageously permanently connected to the spring manner metal, advantageously by spot welding.

The compensation bimetallic strip is preferably rigidly fastened to the power control unit by the fastening end, for example welded to a contact bridge or to a contact plug. The mounting of the release mechanism in spring manner is therefore sufficient for the release mechanism to be in spring-loaded contact with the compensation bimetallic strip.

In a possible development of the invention, an adjustable stop serving to provide direct contact with or pressure against the release may be provided at the free end of the compensation bimetallic strip. The adjustable stop may be a screw extending in the longitudinal direction from the compensation bimetallic strip to contact with the release, for example a grub screw settable from the outside to allow adjustment. Advantageously, this adjustable stop or screw is aligned at right angles to a surface or to a direction of the compensation bimetallic strip.

In a further possible development of the invention, the power control unit may be designed to close and to open the power switch more often than once per minute when an average controlled continuous power output is less than 20% of the maximum or continuous power output. Advantageously, this is provided when the average controlled continuous power is less than 10% or even less than 6% of the maximum continuous power. Since the power control unit may now be switched faster or be tripped faster, switching may also be more frequent and hence a relatively low continuous power may also be set by cycling. A further advantage of this more frequent switching is that not only the average or continuous power seen over time may be set more precisely, but also the temperature fluctuations in a cooking utensil heated by the electric heater may be less due to thermal inertia. This is better and healthier for any food being warmed up or heated therein, precisely because heating is more even.

Alternatively, the aforementioned frequency of switching may, in the case of the low average controlled continuous power output as mentioned above, be such that the power switch is closed and opened less than once per minute. A cycle time may then be longer than one minute, advantageously between one minute and one and a half or even two minutes.

Advantageously, a tolerance in the power setting to the lowest setting position of the power control unit may be in a tolerance range of +/−2.5% of the nominal power value, preferably +/−1.5% of the nominal value.

A heating power of the heating device may be between 4 W and 40 W, preferably between 5 W and 25 W, at room temperature. Additionally or alternatively, the heating conductor of the heating device may have a positive temperature coefficient of its electrical resistance. The heating power of the heating conductor may thus, in one example, be reduced during operation from around 20 W at room temperature to around 10 W at an operating temperature between 400° C. and 500° C.

Additional wiring expenditure may be saved by firmly associating one power control unit with one heater. Furthermore, it may be provided in the case of such an arrangement in a hob with a plurality of heaters that only some of the heaters are provided with a power control unit in accordance with the invention, and the other heaters with a conventional power control unit. This allows some of the heaters to be designed specifically to operate very precisely in the low power range.

A heater is advantageously a radiant heater, wherein it is particularly advantageous that all heaters of the hob are radiant heaters. Each radiant heater is associated with its own power control unit. It may be provided that a continuous surface power output of a heater with a low or lowest possible setting of the power control unit is lower than 0.5 W/cm², in particular lower than 0.25 W/cm², preferably lower than 0.2 W/cm². As stated at the outset, high precision and constancy in a power output setting may be achieved using the power control unit in accordance with the invention precisely in the case of lower or very low average continuous surface power outputs.

Due to the reduced mass of the carrier of the release mechanism, a 20% to 30% faster rise in the heating curve of the heating device may be achieved. The heat throughput or the general heat transmission in the direction of the release are thus markedly faster, so that the release too reacts faster.

A ratio of a switched-on time to the total of switched-on time, and switched-off time, also called the ED value, may be below 5% and hence a very precise adjustment of a low power output is possible. The reduced mass of the carrier also allows the speed to be increased without significantly increasing a maximum temperature of the heating conductor or of the heating device for the bimetallic release. Advantageously, it is at most only 10K above a normal maximum temperature.

In a development of the invention, the power control unit may have a housing for the power switch and the release mechanism, wherein the housing consists of plastic, preferably of a thermoplastic such as, for example, polyphenylene sulfide. This material is available from the company LG Chemical as Lusep GP 4650 NA. The housing may have a housing floor, in particular designed in one piece, on which the power switch and the release mechanism are fastened. The housing floor preferably consists of the same material as the housing.

In an arrangement in accordance with the invention with an electric heater and with a previously described power control unit, the power control unit is fixedly associated with the heater and electrically connected thereto. Advantageously, such an arrangement is a hob with a plurality of electric heaters and with one power control unit per electric heater. Advantageously, the electric heaters are radiant heaters, at least those that are controlled using a power control unit in accordance with the invention.

An average continuous surface power output of a heater controlled using a power control unit in accordance with the invention may, with a low or lowest possible setting of the power control unit, be lower than 0.5 W/cm², in particular lower than 0.25 W/cm². Preferably it may be even lower than 0.2 W/cm².

These and further features are revealed in the description and in the drawings as well as in the claims, wherein the individual features can each be realized singly or severally in the form of sub-combinations in one embodiment of the invention and in other fields, and can represent embodiments advantageous and protectable per se, for which protection is claimed here. The subdivision of the application into individual sections and sub-headings does not limit the statements made thereunder in their general validity.

### BRIEF DESCRIPTION OF THE DRAWINGS

Examples of the invention are shown schematically in the drawings and are explained in more detail in the following. In the drawings:

FIG. 1 shows an interior view of a power control unit in accordance with the invention with closed contacts,

FIG. 2 shows the power control unit of FIG. 1 with heated bimetals and opened contacts,

FIG. 3 shows a simplified schematic representation of the arrangement of compensation bimetallic strip on one hand and the release on the other hand, with bimetals provided in mirrored manner,

FIG. 4 shows a plan view and a side view of a heating device,

FIG. 5 shows a side view of a power control unit in accordance with the invention as an assembly,

FIG. 6 shows a plan view onto a hob in accordance with the invention with four radiant heaters and each with one power control unit,

FIG. 7 shows a diagram with a curve of the average temperature of a heating conductor of the heating device depending on the supply voltage and on a thickness of a ceramic carrier, and

FIG. 8 shows a diagram similar to FIG. 7 with a higher resolution and with consideration of a markedly shorter time at the start of heating up.

### DETAILED DESCRIPTION OF THE EXAMPLES

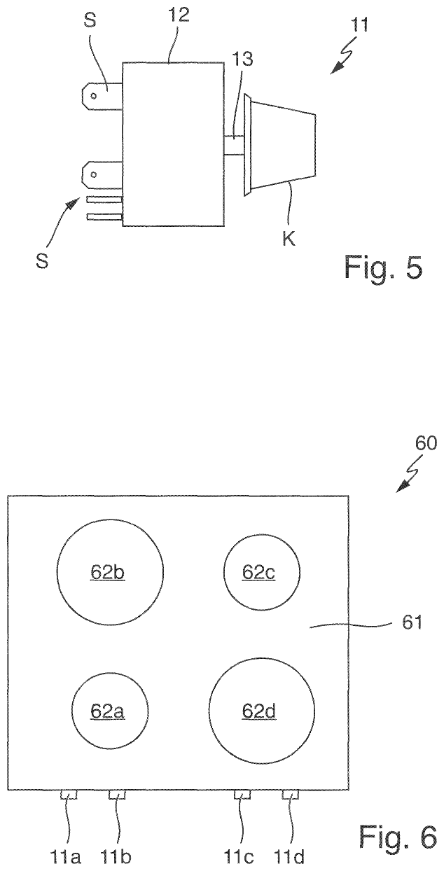

FIG. 1 shows a power control unit 11 in accordance with the invention in the opened state, such that its interior is discernible from the front. The power control unit 11 forms an assembly with a housing 12 and a housing floor 13, on which most of the function units/components shown here are arranged or fastened. They consist of plastic, advantageously of polyphenylene sulfide, such as, for example, Lusep GP4650 NA. This provides good resistance against high temperatures. The power control unit 11 has as a central part a power switch 14, as is known per se from the prior art. The power switch 14 has a switching arm 15, which has on the right a switching arm end 17 and on the left a contact end 22. Some way to the right, next to a switching contact 23 on the contact end 22, part of the switching arm 15 projects upwards and out like a bridge or arch, as a snap-action element 19, and is braced with its right-hand free end against a support 20 with a knife-edge mounting. The parts of the switching arm 15 extend past the snap-action element 19 and the support 20 on both sides. If the point at which the snap-action element 19 contacts the support 20 is below the surface of the switching arm 15 in this area, then the contact end 22 with the power switching contact 23 is pressed upwards by the force of the curved snap-action element 19 in spring manner. The power switching contact 23 is then in contact with a mating contact 25 which is firmly arranged on an immobile mating contact bridge 26. The mating contact bridge 26 is integrally cast or molded in the housing floor 13 and may project at the rear, as shown in FIG. 5 as a plug connection S for electrical connection.

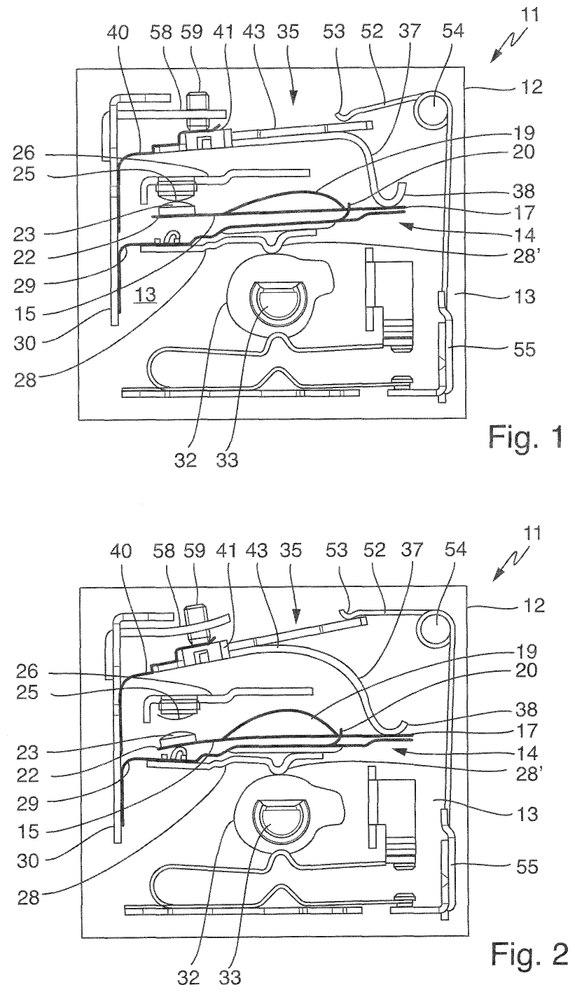

If the point at which the snap-action element 19 is braced against the support 20 is above the surface of the switching arm 15 extending next to it on the left and right, as shown in FIG. 2, then the spring force of the snap-action element 19 presses the contact end 22 downwards. The contact of the power switching contact 23 to the mating contact 25 is hence broken, and there is a sufficient contact distance between them; the switch/power switch 14 is thus open.

The power switch 14 is located in known manner on a switching arm carrier 28 which is fastened to a connecting bridge 30 by means of a spring mounting 29. The spring mounting 29 consists of thin spring metal. The connecting bridge 30 is fastened or integrally molded, similarly to the mating contact bridge 26, in the housing floor 13 and may project as a plug connection S on a rear face of the power control unit 11.

The switching arm carrier 28 has a downward-facing bulge 28′ that contacts an outer circumference of a switching cylinder 32 in spring-like manner due to the spring force of the spring mounting 29. The switching cylinder 32 has a variable diameter, as is known from the prior art. It is mounted on a switching shaft 33 which can be rotated by one operator by means of the knob K, see also FIGS. 5 and 6. Depending on the diameter change in the switching cylinder 32, the switching arm carrier 28 and the entire power switch 14 are then moved upwards or downwards, effecting an adjustment of the previously mentioned ED value and hence a setting of a different continuous power output at a heater controlled by the power control unit 11. The state shown here corresponds to a rotation angle of around 50° and to a relatively low continuous power, corresponding for example to 10% to 20% of a maximum continuous power of the heater. The lower the thickness of the switching cylinder 32, the further the switching arm carrier 28 together with switching arm 15 moves downwards and the longer it takes until the switching arm end 17 is pressed downwards such that the contacts 23 and 25 separate. This is however known from the prior art.

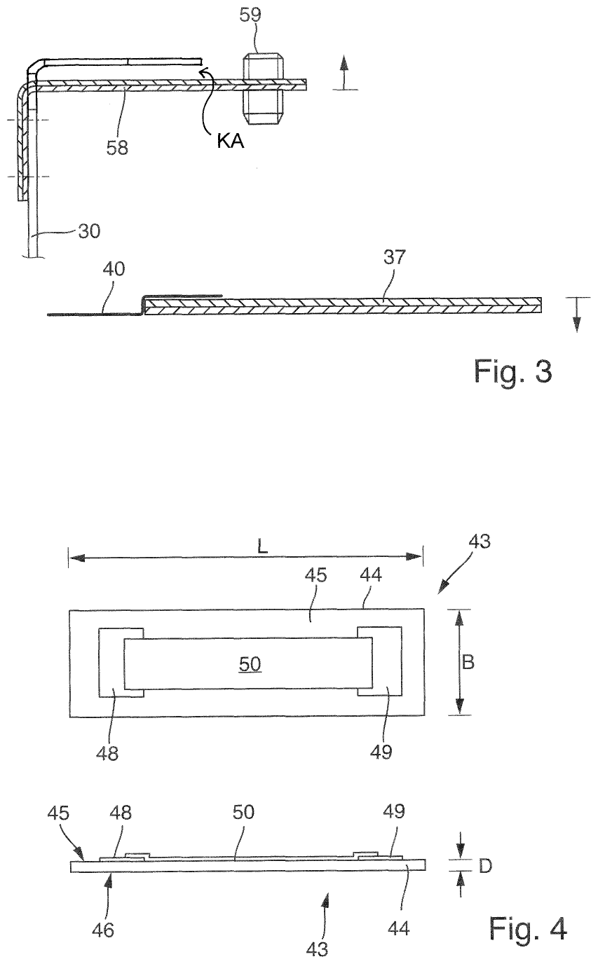

The switching arm end 17 is pressed downwards by the release mechanism 35, namely by a release 37 or by its right-hand lower hook end 38, which presses from above onto the switching arm end 17. The release 37 is an elongate bimetallic strip with a constant width and in the shape shown here. It is connected, advantageously welded, by its left-hand end to a spring mounting 40, which is in turn fastened to the connecting bridge 30. It tries to press the release mechanism 35 in spring manner upwards. The release 37 is designed, as explained in the following with reference to FIG. 3, such that when the left-hand end is fixed, it bends downwards at the right-hand area, in particular at the hook end 38, when the temperature rises.

In addition to the release 37, the release mechanism 35 also has a receptacle 41 which is formed at the end of its spring mounting 40 by the latter. A heating device 43, shown in more detail in FIG. 4, is plugged into this receptacle 41 in a manner known per se to fasten it. The heating device 43 is here in contact with the top side of the release 37, but not fastened thereto, substantially in the left-hand area. A spring end 53 of a contact spring 52 is in contact with the right-hand end on the top side of the heating device 43. The contact spring 52 is fastened at bottom right to a contact bridge 55, wherein the contact bridge 55 is in turn advantageously integrally cast or molded into the housing floor 13 and projects at a rear face as a plug connection S. The contact spring 52 is mounted at top right on a bearing pin 54, about which it is wound multiple times. The spring force of the spring end 53 presses downwards here. The contact spring 52 forms one electrical contact with the heating device 43. The other electrical contact is formed by the receptacle 41 plus spring mounting 40.

A compensation bimetallic strip 58, which is designed approximately rectangular, is also fastened to the top of the connecting bridge 30. At its right-hand end, an adjusting screw 59 is screwed into the compensation bimetallic strip 58, and is here designed as a grub screw or hexagon socket screw. The adjusting screw 59 is in contact with the receptacle 41. The release mechanism 35 may be moved downwards and towards the switching arm 15 and the switching cylinder 32, or away from them, respectively by tightening or undoing the adjusting screw 59 with the compensation bimetallic strip 58 being immovable. An adjustment of the power control unit 11 to the release temperature or to the release point may thus be made, i.e. the precision of the power control unit 11 may be adjusted.

The bimetallic structure of the compensation bimetallic strip 58 can be seen more clearly in FIG. 3. The compensation bimetallic strip 58 may have a specific thermal curvature of between 0.00003/K and 0.00006/K. It may advantageously be the aforementioned SBCL/DS/751-108, made by Shivalik. The layer sequence is, as the respective hatching makes clear, precisely mirrored by that of the release 37 arranged underneath. While the release 37 when heated thus bends away downwards at its left-hand free end, starting from its fastening to the spring mounting 40, the compensation bimetallic strip 58 bends upwards, starting from the left-hand fastened end. A compensation distance KA from the stop, i.e. a distance between the compensation bimetallic strip 58 and its stop, may thus be provided in a range between 0 and 1.0 mm, preferably between 0 and 0.8 mm. This stop is formed here by the connecting bridge 30, in particular by its right-hand outer end, as can be seen from FIG. 2, wherein the connecting bridge 30 and hence the stop does not give way. The compensation bimetallic strip 58 may therefore not deform or bend any further than this stop, while traveling at most the stated compensation distance KA. The compensation distance KA is formed by the clear width between the end of the connecting bridge 30 and the top side of the compensation bimetallic strip 58, see also FIG. 1, where the compensation bimetallic strip 58 is in contact with the stop, i.e. is at its maximum deflection, so that the release mechanism 35 too is at its maximum upward deflection.

This bending movement is indicated in each case by the arrows next to them on the right. If the temperature at the power control unit 11 now steeply increases, for example because it has been in operation for some time and because an oven arranged underneath a hob has greatly heated up for a while, then the bimetallic release 37 bends slightly downwards solely due to the higher ambient temperature. The compensation bimetallic strip 58 in turn bends slightly upwards, at most as far as the stop formed by the connecting bridge 30. It is now designed and arranged such that the resultant effect at the release 37 is neutralized by the compensation bimetallic strip 58, or the two movements resulting due to the higher ambient temperature cancel each other out or compensate for one another.

Whereas FIG. 1 shows a state of the power control unit 11 when it is switched on and when a temperature at the compensation bimetallic strip 58 is around 25° C., FIG. 2 shows a state in which a temperature of 125° C. prevails at the compensation bimetallic strip 58. This may be reached when there are, for example, 170° C. at the heating device 43 itself. Furthermore, the heating device 43 is in operation and heats up the release 37 quite strongly due to the closed power switch 14, i.e. when the power switching contact 23 and the mating contact 25 are in contact with one another. This happens particularly quickly in the case of the design in accordance with the invention with the thin carrier of the heating device 43.

Due to rapid heating up, the release 37 has quickly bent downwards, to the extent that it has opened the power switch 14 in the manner as previously described. The power switching contact 23 has separated from the mating contact 25. When the power switch 14 is opened, the heating device 43 is no longer heated, so that the release 37 cools down again and bends back upwards. At a certain point in time, namely when the contact point of the snap-action element 19 on the support 20 has moved back below the surface of the switching arm 15 next to it, the power switch 14 closes again. Then the heating device 43 is also operated again, with renewed heating of the release 37.

As can be discerned, the compensation bimetallic strip 58 has bent markedly upwards due to the relatively high temperature of 125° C. As a result, the spring force of the spring mounting 40 can press the complete release mechanism 35 further upwards. Without this compensatory effect, the hook end 38 of the release 37 would have pressed the switching arm end 17 even further down, and the power switch 14 would have been opened earlier, but only due to being greatly heated. There would thus have been a markedly different switching behavior than in the cool state, which shows itself to be disruptive particularly in the case of low continuous power outputs. In the case of the very low or minimum power outputs of, for example, 5% of the maximum continuous power as mentioned at the outset, divergences show themselves to be even greater and more disruptive.

The second aspect mentioned at the outset with the compensation bimetallic strip 58 is thus explained. The first aspect mentioned at the outset is explained with reference to FIG. 4. This shows the heating device 43, which has a ceramic carrier 44. This may for example consist of silicon nitride and be electrically insulating. The ceramic carrier 44 is elongate and rectangular with a width B, a length L and a thickness D. This thickness D is here 0.63 mm and hence markedly thinner than usual substrates, whose thickness is more than 1 mm or even more than 1.5 mm. On a top side 45 of the carrier, a first contact field 48 is attached on the left, and a second contact field 49 on the right, in each case close to the end. A heating conductor 50 attached thereon, and designed as a thick-film heating element, extends between them. It has PCT properties. Its power output may be a few watts, for example 5 W or 10 W.

The left-hand first contact field 48 is electrically contacted by means of the receptacle 41. The contact spring 52 is in contact with the right-hand second contact field 49 by its spring end 53 for electrical contact. This arrangement of the heating device 43 in the power control unit 11 according to FIG. 1 is such that the top side 45 with the heating conductor 50 faces away from the release 37 underneath, the latter therefore extending close to the underside 46 of the ceramic carrier 44. An even faster heating up of the release 37 could indeed be achieved if the heating conductor 50 were to be arranged on the underside 46 of the ceramic carrier 44 that faces it. In particular, electrical contacting by means of the contact spring 52 would then be more difficult, albeit not impossible. The surface of the heating conductor 50 would of course then have to be electrically insulated from the bimetallic release 37, which may have at least one partially electrically conducting surface.

FIG. 5 shows a complete power control unit 11 in a greatly simplified side view. Several plug connections S project out from a rear face of the housing 12, which are integrally cast or molded into the housing floor 13 according to FIG. 1. The electrical connection of the power control unit 11 is made using these.

A knob K acting as a manual control is placed at the front on the switching shaft 33. Turning it rotates the switching shaft 33 and hence also the switching cylinder 32 and changes the power switch 14 in its position, in particular in its distance from the release 37.

FIG. 6 shows a hob 60 in accordance with the invention as the arrangement mentioned at the outset in accordance with the invention. The hob 60 has a hob plate 61 with four radiant heaters 62a, 62b, 62c and 62d on or underneath the hob plate 61. Radiant heaters of this type have long been known and were for a long time the standard for such heaters. In this connection, reference is made for example to U.S. Pat. No. 5,498,853 A.

Four power control units 11a, 11b, 11c and 11d each with a knob Ka, Kb, Kc and Kd respectively are arranged at the front on the hob 60. Here the power control unit 11a with the knob Ka is associated with the radiant heater 62a to operate it, and so forth.

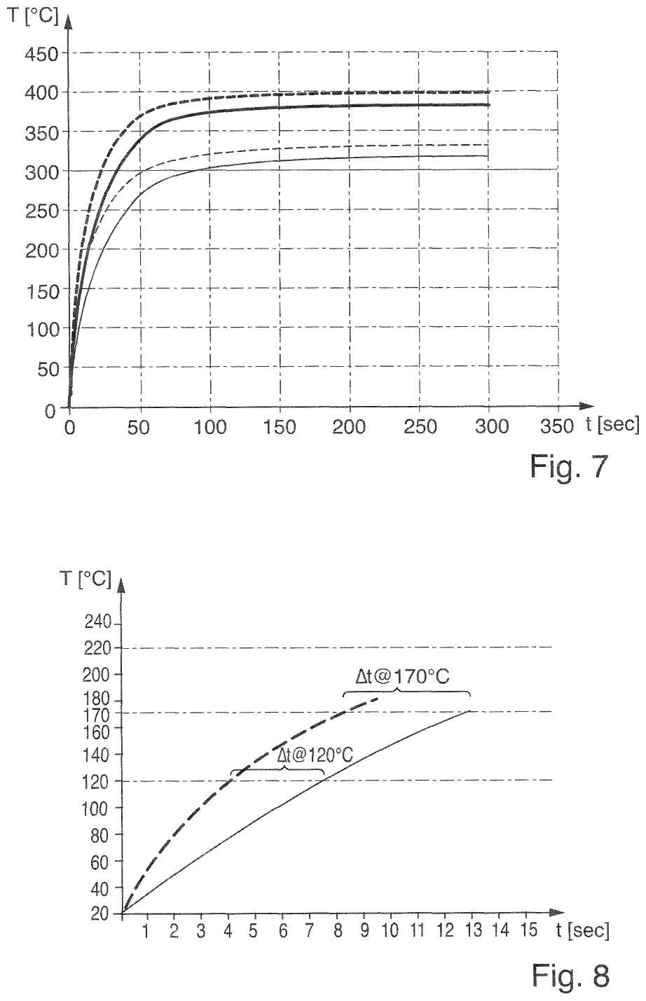

FIG. 7 is a diagram showing the development of the average temperature of the heating conductor 50 of the heating device 43 over time. The solid curves correspond here to a heating device according to the prior art with a ceramic carrier having a thickness of 1.5 mm. The lower and thin solid curve corresponds to a development during operation with a voltage of 230V. This curve is achieved by a temperature of slightly over 330° C. after about 150 sec. In order to simulate a theoretically possible power increase, a higher voltage of 280V is used, resulting in a temperature development corresponding to the upper and thick solid curve. This curve is achieved at a temperature of 370° C.

The curves for the heating device in accordance with the invention with the thin ceramic carrier are shown as dashed lines. The thin dashed curve is for operation with a mains voltage of 230V. The temperature eventually achieved is around 330° C., after three to four minutes. If the supply voltage is increased here too from 230V to 280V, then the temperature rises, and the maximum continuous temperature is then around 400° C. This is the thick dashed curve. It is achieved after a similar time.

It can be discerned from the curves, in particular at the start of heating up, that a reduction in the thickness of the heating device has considerably greater effects on the rapid increase in the temperature than if only the heating power is increased. In this connection, reference is also made to FIG. 8, which also shows the temperature over time, but in a different scale and with a supply voltage of 230V. This is therefore the temperature of the heating device itself. It shows on the left as a dashed line the temperature development for the thin ceramic carrier 44 of the heating device 43 in accordance with the invention. With this, a temperature of 120° C. is already achieved after a time of 4 sec, and after 8 sec a temperature of 170° C. To attain the temperature of 120° C., a heating device with a conventional and thicker ceramic carrier according to the prior art needs around 7.5 sec, i.e. 3.5 sec longer. The higher temperature of 170° C. is reached after 13 sec, which is already a time difference of 5 sec.

It can be seen from this that the reduction in thickness of the carrier of the heating device 43 has a greater and better effect than just by using a more powerful heater or more powerful heating conductor. The increase in the power of the heating device or of the heating conductor admittedly also effects faster heating up and hence faster switching of the power control unit. However, the concomitant effects from higher end temperature and hence from greater heating up of the interior of the power control unit, which usually and advantageously has a housing of plastic, are very disadvantageous in comparison.

Advantageously, it is provided that the heating conductor 50 has PTC properties in its electrical resistance. It is thus ensured that the heating device does not run away, so to speak, due to excessive heating during operation.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. A power control unit for controlling a power output of an electric heater, wherein said power control unit is designed as an assembly and has:
a power switch designed as a snap-action switch with a switching arm with a switching arm end and a contact end, with a power switching contact and with a release, wherein said power switching contact is arranged at said contact end of said switching arm end, wherein said release is in contact with said switching arm end to trigger a switching operation,
a release mechanism for said power switch, wherein said release mechanism has a release with a bimetal and has a heating device for said release, wherein said release is in contact with said switching arm end of said switching arm by a free release end, wherein said heating device extends at least partially along said release and at a short distance to said release, in particular less than 2 mm in the state of said release at room temperature, wherein said heating device has a two-dimensional carrier with an electrically insulating top side, wherein a heating conductor is arranged on said top side, in particular a thick-film conductor,
wherein:
said carrier consists of a ceramic and has a thickness of less than 1.5 mm, and/or
said power control unit has an elongate compensation bimetallic strip, said elongate compensation bimetallic strip having a freely movable compensation end, said compensation end being pressed against said release mechanism, wherein
said compensation bimetallic strip and said release mechanism are in spring-loaded contact with one another,
said compensation bimetallic strip is designed such that a movement direction of said free compensation end is at an angle of between 0° and 45° to a movement direction of that area of said release mechanism against which said compensation end is pressed,
said compensation bimetallic strip is fastened to said power control unit by another fastening end.

25. The power control unit according to claim 24, wherein said compensation bimetallic strip is designed such that said compensation end moves away from said release mechanism as a temperature rises.

26. The power control unit according to claim 24, wherein said compensation bimetallic strip has a specific thermal curvature of between 0.00003/K and 0.00006/K, in particular of 0.000043/K, wherein preferably said compensation bimetallic strip is SBCL/DS/751-108.

27. The power control unit according to claim 24, wherein a compensation distance is provided as a distance between said compensation bimetallic strip and a stop of said com- pensation bimetallic strip in a range between 0 mm and 1.0 mm, preferably between between 0 mm and 0.8 mm.

28. The power control unit according to claim 27, wherein said compensation bimetallic strip is fastened by said fastening end to said power control unit, in particular fastened to a connecting bridge, wherein said connecting bridge is fastened firmly to a housing of said power control unit, wherein said connecting bridge forms said stop of said compensation bimetallic strip.

29. The power control unit according to claim 24, wherein said release consists of a bimetal or is a bimetal and is fastened to said release mechanism by another end being opposite said release end.

30. The power control unit according to one of the preceding claims, wherein said release mechanism is mounted in spring manner, while said compensation bimetallic strip is rigidly fastened to said power control unit by said fastening end such that said release mechanism is in spring-loaded contact with said compensation bimetallic strip.

31. The power control unit according to claim 24, wherein an adjustable stop for contact with said release is provided on said free compensation end of said compensation bimetallic strip, in particular a screw extending in a longitudinal direction from said compensation bimetallic strip to a contacting at said release.

32. The power control unit according to according to claim 24, being designed to close and to open said power switch more often than once per minute when an average controlled continuous power output is less than 20% of said maximum or said continuous power output, in particular less than 10% of said maximum continuous power output, preferably less than 5% of said maximum continuous power output.

33. The power control unit according to claim 24, wherein a tolerance at said lowest setting position of said power control unit is in a tolerance range of +/−1.5% of said nominal value.

34. The power control unit according to claim 24, wherein a heating power of said heating device is between 4 W and 40 W at room temperature, preferably between 10 W and 25 W.

35. The power control unit according to claim 24, wherein said carrier has a thickness of less than 1 mm, preferably has a thickness of between 0.1 mm and 0.75 mm.

36. The power control unit according to claim 24, having a housing for said power switch and said release mechanism, wherein said housing consists of plastic, preferably of thermoplastic such as for example polyphenylen sulfide, wherein in particular said housing has a housing floor, on which said power switch and said release mechanism are fastened, wherein preferably said housing floor consists of the same material as the housing.

37. An arrangement of a power control unit according to claim 24 with an electric heater, in particular with a radiant heater, wherein said power control unit is fixedly associated with said heater and is electrically connected to said heater, wherein preferably said arrangement is a hob with a hob plate.

38. The arrangement according to claim 37, wherein a continuous average surface power output of said electric heater with a low or lowest possible setting of the power control unit is lower than 0.5 W/cm², in particular lower than 0.25 W/cm², preferably lower than 0.2 W/cm².
